(19) United States
(12) Patent Application Publication
(10) Pub. No.: US 2024/0390863 A1
(43) Pub. Date: Nov. 28, 2024

(54) SEPARATION MEMBRANE COMPLEX, MIXED GAS SEPARATION APPARATUS, AND METHOD OF PRODUCING SEPARATION MEMBRANE COMPLEX

(71) Applicant: NGK INSULATORS, LTD., Nagoya-City (JP)

(72) Inventors: Kenichi NODA, Nagoya-City (JP); Makoto MIYAHARA, Tajimi-City (JP)

(73) Assignee: NGK INSULATORS, LTD., Nagoya-City (JP)

(21) Appl. No.: 18/792,687

(22) Filed: Aug. 2, 2024

Related U.S. Application Data
(63) Continuation of application No. PCT/JP2023/001689, filed on Jan. 20, 2023.

(30) Foreign Application Priority Data
Feb. 8, 2022 (JP) 2022-017638

(51) Int. Cl. B01D 69/02; B01D 53/22; B01D 67/00; B01D 71/02

(52) U.S. Cl. CPC B01D 69/02; B01D 53/228; B01D 67/0051; B01D 71/0281; B01D 2256/245; B01D 2257/504; B01D 2325/06

(57) ABSTRACT

A separation membrane complex includes a porous support and a separation membrane formed on the support. In the separation membrane complex, average CF₄ permeance of one membranous end portion is 5 times or more and 100 times or less of average CF₄ permeance of a membranous central portion, the one membranous end portion being a portion of the separation membrane that is within a range of one-tenth of the longitudinal length of the separation membrane from one longitudinal edge of the separation membrane, the membranous central portion being a portion of the separation membrane excluding the membranous end portions on both longitudinal sides of the separation membrane.

### CROSS-REFERENCE TO RELATED APPLICATIONS

The present application is a continuation application of International Application No. PCT/JP2023/001689 filed on Jan. 20, 2023, which claims the benefit of priority to Japanese Patent Application No. 2022-017638 filed on Feb. 8, 2022. The entire contents of these applications are incorporated herein by reference.

### TECHNICAL FIELD

The present invention relates to a separation membrane complex, a mixed gas separation apparatus, and a method of producing a separation membrane complex.

### BACKGROUND ART

Various studies and developments are currently underway on processing such as separation or adsorption of specific molecules by using a separation membrane such as a zeolite membrane.

For example, International Publication No. 2016/104048 (Document 1) and International Publication No. 2016/104049 (Document 2) disclose gas separation modules for separating a specific gas from a mixed gas with a gas separation membrane structure in which a gas separation membrane is formed on a porous support. In the gas separation modules, the internal space of a housing is separated into two spaces with the plate-like gas separation membrane structure and the mixed gas is supplied into one of the two spaces (i.e., the space on the feed side). Then, the specific gas (hereinafter, referred to as the “to-be-permeated gas”) in the mixed gas permeates the gas separation membrane structure and flows to the other space (i.e., the space on the permeate side) and is separated from the mixed gas. In the case where the concentration of the to-be-permeated gas in the mixed gas is low, in the gas separation module, a sweep gas is flowed into the space on the permeate side so as to lower the partial pressure of the to-be-permeated gas in the space on the permeate side and to accelerate the permeation of the to-be-permeated gas.

International Publication No. 2016/093192 (Document 3) and Japanese Patent Application Laid-Open No. 2009-214075 (Document 4) disclose monolith-type separation membrane complexes that include a column-like porous support and a separation membrane, the porous support having a plurality of through holes (i.e., cells) each extending in the longitudinal direction, the separation membrane being formed on the inner surfaces of the cells. In the separation membrane complexes, the porous support has longitudinal end portions each formed with a sealer having contact with the separation membrane, and there is the problem that cracks are likely to occur in portions of the separation membrane that are in close proximity to the sealers (i.e., longitudinal end portions of the separation membrane). In view of this, Document 4 proposes a technique for providing a membranous covering zeolite on boundary portions between the separation membrane and the sealers to cover both of the separation membrane and the sealers so as to suppress leakage of gases other than the to-be-permeated gas from cracks.

In the case of separating a to-be-permeated gas having a lower concentration from a mixed gas by using such a monolith-type separation membrane complex as disclosed in Document 3 or 4, it is conceivable to flow a sweep gas into the space outside the column-like porous support. However, the effect of accelerating permeation by the sweep gas is not so much exerted on cells that are distant from the space where the sweep gas flows (e.g., cells located in the vicinity of the central portion of the porous support in a section perpendicular to the longitudinal direction), so that there is a limit to improving the performance of separating a mixed gas. Besides, defects such as cracks occurring in the longitudinal end portions of the separation membrane are focused on only in terms of reducing the defects, and there has been no idea of actively using such defects for improving the separation performance.

### SUMMARY OF THE INVENTION

The present invention is intended for a separation membrane complex, and it is a main object of the present invention to improve the separation performance of the separation membrane complex.

A separation membrane complex according to one preferable embodiment of the present invention includes a porous support and a separation membrane formed on the support. Average CF₄ permeance of one membranous end portion is 5 times or more and 100 times or less of average CF₄ permeance of a membranous central portion, the one membranous end portion being one of membranous end portions of the separation membrane that are within a range of one-tenth of a longitudinal length of the separation membrane from both longitudinal edges of the separation membrane, the membranous central portion being a portion of the separation membrane excluding the membranous end portions on both longitudinal sides.

The separation membrane complex according to the present invention achieves improved separation performance.

Preferably, the average CF₄ permeance of the one membranous end portion is 5 times or more and 50 times or less of the average CF₄ permeance of the membranous central portion.

Preferably, average CF₄ permeance of the other membranous end portion is 5 times or more and 100 times or less of the average CF₄ permeance of the membranous central portion.

Preferably, the separation membrane complex further includes a sealer that covers and seals a surface of the support on a side opposite to a surface of the support that is in contact with the one membranous end portion, in a region of the support where the one membranous end portion is placed. The sealer extends from a position facing the one membranous end portion with the support sandwiched in between to a position facing the membranous central portion with the support sandwiched in between.

Preferably, the separation membrane is a zeolite membrane.

Preferably, a zeolite constituting the zeolite membrane is composed of an 8- or less-membered ring at a maximum.

Preferably, the support has a column-like shape extending in a longitudinal direction. The separation membrane is formed on an inner surface of a membrane-formed cell that penetrates the support in the longitudinal direction.

The present invention is also intended for a mixed gas separation apparatus. A mixed gas separation apparatus according to one preferable embodiment of the present invention includes the separation membrane complex according to any one of claims 1 to 7, and a housing that includes the separation membrane complex. The housing is connected to a supplier that supplies a mixed gas containing a plurality of types of gases to the separation membrane complex, a permeated gas collector that collects a permeated gas in the mixed gas, the permeated gas having permeated the separation membrane complex, and a non-permeated gas collector that collects a non-permeated gas in the mixed gas, the non-permeated gas having not permeated the separation membrane complex.

Preferably, the mixed gas contains one or more types of substances among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

The present invention is also intended for a method of producing a separation membrane complex. A method of producing a separation membrane complex according to one preferable embodiment of the present invention includes a) bringing a porous support into contact with a dispersion in which seed crystals of a zeolite are dispersed, to deposit the seed crystals on the support, b) immersing the support having the seed crystals deposited thereon in a starting material solution and growing the zeolite from the seed crystals by hydrothermal synthesis to form a zeolite membrane as a separation membrane on the support, and c) before the operation a), bringing a portion of the support that is within a range of one-tenth or less of a longitudinal length of the support from a longitudinal edge of the support, into contact with a liquid that has a lower concentration of the seed crystals than the dispersion.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective view of a separation membrane complex according to one embodiment.

FIG. 2 is a diagram showing one end face of the separation membrane complex.

FIG. 3 is a sectional view of the separation membrane complex.

FIG. 4 is a diagram showing another example of one end face of the separation membrane complex.

FIG. 5 is a sectional view showing the vicinity of one end portion of a first cell in enlarge dimensions.

FIG. 6 is a sectional view showing the vicinity of one end portion of a first cell in enlarged dimensions.

FIG. 7 is a flowchart showing the production of the separation membrane complex.

FIG. 8A is a diagram showing the separation membrane complex in the process of being produced.

FIG. 8B is a diagram showing the separation membrane complex in the process of being produced.

FIG. 8C is a diagram showing the separation membrane complex in the process of being produced.

FIG. 8D is a diagram showing the separation membrane complex in the process of being produced.

FIG. 8E is a diagram showing the separation membrane complex in the process of being produced.

FIG. 8F is a diagram showing the separation membrane complex in the process of being produced.

FIG. 8G is a diagram showing the separation membrane complex in the process of being produced.

FIG. 8H is a diagram showing the separation membrane complex in the process of being produced.

FIG. 9 is a sectional view of a separation apparatus.

FIG. 10 is a flowchart showing the separation of a mixed gas.

FIG. 11 is a sectional view showing the vicinity of one end portion of a first cell in enlarged dimensions.

### DETAILED DESCRIPTION

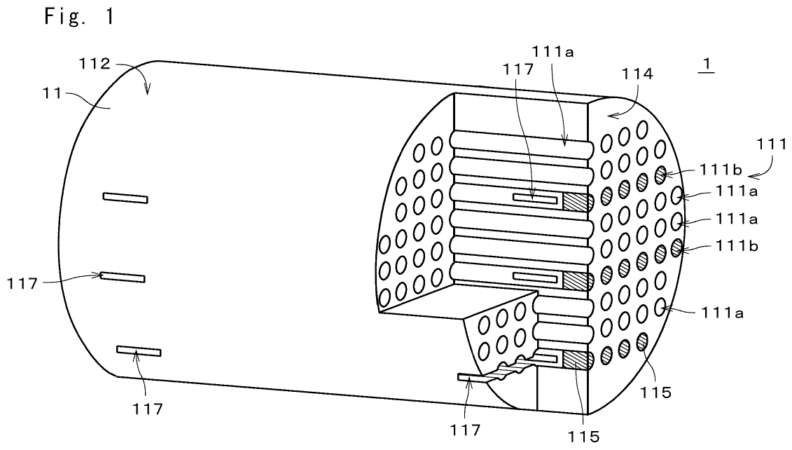

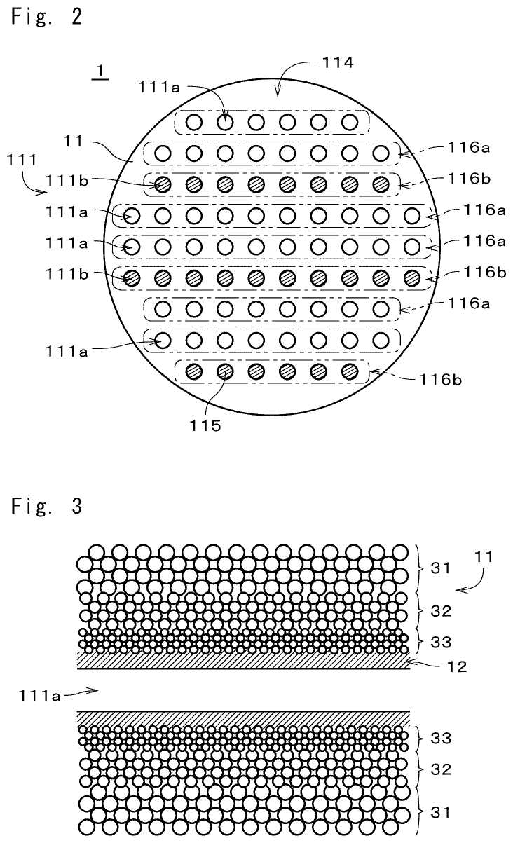

FIG. 1 is a perspective view of a separation membrane complex 1 according to one embodiment of the present invention. FIG. 1 also shows part of the internal structure of the separation membrane complex 1. FIG. 2 is a diagram showing one end face 114 in the longitudinal direction of the separation membrane complex 1 (i.e., approximately the right-left direction in FIG. 1). FIG. 3 is a diagram showing part of a longitudinal section of the separation membrane complex 1 in enlarged dimensions and shows the vicinity of one cell 111, which will be described later. For example, the separation membrane complex 1 may be used to separate a specific gas from a mixed gas in a mixed gas separation apparatus 2, which will be described later.

The separation membrane complex 1 includes a porous support 11 and a separation membrane 12 (see FIG. 3) formed on the support 11. In FIG. 3, the separation membrane 12 is cross-hatched. The support 11 is a porous member that is permeable to gas and liquid. In the example shown in FIG. 1, the support 11 is a monolith-type support that includes an integrally molded column-like body having a plurality of through holes 111 (hereinafter, also referred to as “cells 111”) each extending in the longitudinal direction of the body. In the support 11, the cells 111 are formed (i.e., partitioned) by a porous partition wall. In the example shown in FIG. 1, the support 11 has an approximately column-like outside shape. Each cell 111 may have, for example, an approximately circular sectional shape perpendicular to the longitudinal direction. Note that “approximately circular” denotes a concept that includes not only a perfect circle but also an ellipse or a distorted circle. It is preferable that each cell 111 may have a perfect circular sectional shape, but this sectional shape does not necessarily need to be a perfect circle. In the illustration of FIG. 1, the diameter of the cells 111 is greater than the actual diameter, and the number of cells 111 is smaller than the actual number (the same applies to FIG. 2). In the illustration of FIG. 3, the thickness of the separation membrane 12 is greater than the actual thickness.

The cells 111 include first cells 111a and second cells 111b. In the example shown in FIGS. 1 and 2, the first cells 111a and the second cells 111b have approximately the same shape. The openings of the second cells 111b are plugged by a plugging member 115 in both longitudinal end faces 114 of the support 11. In other words, the second cells 111b have both longitudinal ends closed. In FIGS. 1 and 2, the plugging member 115 is cross-hatched. Meanwhile, the openings of the first cells 111a are not plugged but open in both of the longitudinal end faces 114 of the support 11.

The aforementioned separation membrane 12 (see FIG. 3) is formed on the inner surface of each first cell 111a having both longitudinal ends open. Preferably, the separation membrane 12 may be formed to cover the entire inner surface of each first cell 111a. That is, the first cells 111a are membrane-formed cells on the inner side of which the separation membrane 12 is formed. In the separation membrane complex 1, the separation membrane 12 is not formed on the inner side of the second cells 111b. As will be described later, the second cells 111b are exhaust cells that are used to exhaust a permeated gas that has permeated the separation membrane 12.

In the example shown in FIGS. 1 and 2, the cells 111 are arranged in the lengthwise direction (i.e., the up-down direction in FIG. 2) and the lateral direction in a matrix in the end faces 114 of the support 11. In the following description, a group of cells 111 that are arranged in a line in the lateral direction (i.e., the right-left direction in FIG. 2) is also referred to as a “cell line.” The cells 111 include a plurality of cell lines aligned in the lengthwise direction. In the example shown in FIG. 2, each cell line is composed of a plurality of first cells 111a or a plurality of second cells 111b.

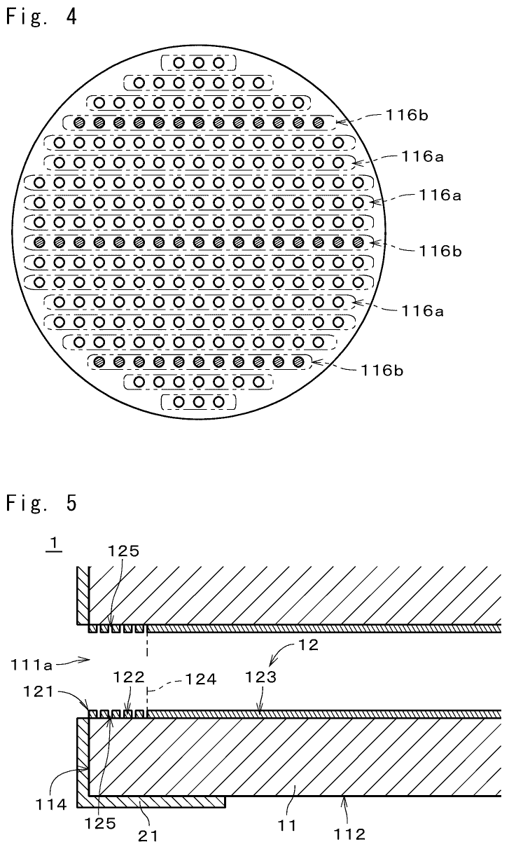

In the example shown in FIG. 2, the cell lines are arranged such that one cell line of second cells 111b (hereinafter, also referred to as a “second cell line 116b”) and two cell lines of first cells 111a (hereinafter, also referred to as “first cell lines 116a”) are alternately arranged adjacent to one another in the lengthwise direction. In FIG. 2, the first cell lines 116a and the second cell lines 116b are each enclosed by a chain double-dashed line (the same applies to FIG. 4, which will be described later). The second cell lines 116b are plugged cell lines having both longitudinal ends plugged.

A plurality of second cells 111b in each second cell line 116b communicate with one another via slits 117 (see FIG. 1) extending in the lateral direction. The slits 117 extend to an outer surface 112 of the support 11 on both lateral sides of the second cell line 116b, so that the second cells 111b in the second cell line 116b communicate with the space outside the support 11 via the slits 117. For example, each slit 117 may have an approximately rectangular sectional shape perpendicular to the lateral direction. The sectional shape of the slit 117 may be changed to any of various shapes such as an approximately circular shape. Note that the sections of the slit 117 is much larger than the sections of the pores of the support 11. In the separation membrane complex 1 shown in FIG. 1, three slits 117 are formed in the vicinity of each longitudinal end portion of the support 11. Since each slit 117 is open into the outer surface of the support 11 on both lateral sides, there are six openings (hereinafter, also referred to as “slit openings”) in the vicinity of each end portion on the outer surface of the support 11. These six slit openings are of approximately the same shape and located at approximately the same longitudinal position. Note that some or all of the slit openings (the aforementioned six slit openings) may differ in shape or position in the vicinity of the longitudinal end portions of the support 11.

The first cell lines 116a are open cell lines having both longitudinal ends open and are also membrane-formed cell lines on the inner side of which the separation membrane 12 is formed (see FIG. 3). Two lines of first cells 111a that are adjacent to one lengthwise side of one second cell line 116b form an open cell line group. In other words, the open cell line group refers to two first cell lines 116a that are sandwiched between two second cell lines 116b that are located in closest proximity to each other in the lengthwise direction.

The number of first cell lines 116a configuring one open cell line group is not limited to two, and may be changed variously. Preferably, the number of first cell lines 116a configuring one open cell line group may be greater than or equal to one and less than or equal to six and more preferably one or two. FIG. 4 shows an example in which five first cell lines 116a configure one open cell line group sandwiched between two second cell lines 116b.

The number of second cell lines 116b is also not limited to three, and may be one or may be two or more. In the separation membrane complex 1, the second cells 111b do not necessarily need to be aligned in the lateral direction, and may be arranged at random intervals. As another alternative, the number of second cells 111b provided in the separation membrane complex 1 may be one. As yet another alternative, the second cells 111b may be omitted, and only the first cells 111a may be provided in the separation membrane complex 1.

The support 11 may have a longitudinal length of, for example, 100 mm to 2000 mm. The support 11 may have an outside diameter of, for example, 5 mm to 300 mm. The cell-to-cell distance between each pair of adjacent cells 111 (i.e., the thickness of the support 11 between portions of the adjacent cells 111 that are in closest proximity to each other) may be in the range of, for example, 0.3 mm to 10 mm. Surface roughness (Ra) of the inner surfaces of the first cells 111a of the support 11 may be in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 may be in the range of, for example, 0.1 mm to 10 mm.

A sectional area of each cell 111 perpendicular to the longitudinal direction may be in the range of, for example, greater than or equal to 2 mm² and less than or equal to 300 mm². In the case where this section of each cell 111 has an approximately circular shape as described above, the diameter of this section may preferably be in the range of 1.6 mm to 20 mm. Note that the shape and size of the cells 111 may be changed variously. For example, the cells 111 may have an approximately polygonal sectional shape perpendicular to the longitudinal direction. The first cells 111a and the second cells 111b may differ in shape and size. Moreover, some or all of the first cells 111a may differ in shape and size, and some or all of the second cells 111b may differ in shape and size.

The material for the support 11 may be any of various substances (e.g., ceramic or metal) as long as this substance has chemical stability in the process of forming the separation membrane 12 on the surface of the support 11. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. In the present embodiment, the support 11 contains at least one of alumina, silica, and mullite.

The support 11 may contain an inorganic binder for binding aggregate particles of the aforementioned ceramic sintered body. As the inorganic binder, at least one of titania, mullite, easily sinterable alumina, silica, glass frit, clay minerals, and easily sinterable cordierite may be used.

The support 11 may have, for example, a multilayer structure in which a plurality of layers having different mean pore diameters are laminated one above another in the thickness direction in the vicinity of the inner surface of each first cell 111a as an open cell (i.e., in the vicinity of the separation membrane 12). In the example shown in FIG. 3, the support 11 includes a porous base material 31, a porous intermediate layer 32 formed on the base material 31, and a porous surface layer 33 formed on the intermediate layer 32. That is, the surface layer 33 is indirectly formed on the base material 31 via the intermediate layer 32. The intermediate layer 32 is formed between the base material 31 and the surface layer 33. The surface layer 33 configures the inner surface of each first cell 111a of the support 11, and the separation membrane 12 is formed on the surface layer 33. The surface layer 33 may have a thickness of, for example, 1 μm to 100 μm. The intermediate layer 32 may have a thickness of, for example, 100 μm to 500 μm. Note that the intermediate layer 32 and the surface layer 33 may or may not be formed on the inner surface of each second cell 111b. Also, the intermediate layer 32 and the surface layer 33 may or may not be formed on the outer surface 112 and the end faces 114 of the support 11.

The mean pore diameter of the surface layer 33 is smaller than the mean pore diameters of the intermediate layer 32 and the base material 31. The mean pore diameter of the intermediate layer 32 is smaller than the mean pore diameter of the base material 31. The mean pore diameter of the base material 31 may, for example, be greater than or equal to 1 μm and less than or equal to 70 μm. The mean pore diameter of the intermediate layer 32 may, for example be greater than or equal to 0.1 μm and less than or equal to 10 μm. The mean pore diameter of the surface layer 33 may, for example, be greater than or equal to 0.005 μm and less than or equal to 2 μm. The mean pore diameters of the base material 31, the intermediate layer 32, and the surface layer 33 can be measured by, for example, a mercury porosimeter, a perm porometer, or a nano-perm porometer.

The surface layer 33, the intermediate layer 32, and the base material 31 have approximately the same porosity. The porosities of the surface layer 33, the intermediate layer 32, and the base material 31 may, for example, be higher than or equal to 15% and lower than or equal to 70%. The porosities of the surface layer 33, the intermediate layer 32, and the base material 31 can be measured by, for example, the Archimedes method, mercury porosimetry, or image analysis.

The base material 31, the intermediate layer 32, and the surface layer 33 may be formed of the same material, or may be formed of different materials. For example, the base material 31 and the surface layer 33 may contain Al₂O₃ as a chief material. The intermediate layer 32 may contain aggregate particles that contain Al₂O₃ as a chief material, and an inorganic binder that contains TiO₂ as a chief material. In the present embodiment, the aggregate particles of the base material 31, the intermediate layer 32, and the surface layer 33 are substantially formed of only Al₂O₃. The base material 31 may contain an inorganic binder such as glass.

The average particle diameter of the aggregate particles in the surface layer 33 is smaller than the average particle diameter of the aggregate particles in the intermediate layer 32. The average particle diameter of the aggregate particles in the intermediate layer 32 is smaller than the average particle diameter of the aggregate particles in the base material 31. The average particle diameters of the aggregate particles in the base material 31, the intermediate layer 32, and the surface layer 33 can be measured by, for example, a laser diffraction method.

The plugging member 115 may be formed of a material similar to the material(s) for the base material 31, the intermediate layer 32, and the surface layer 33. The porosity of the plugging member 115 may be in the range of, for example, 15% to 70%.

As described above, the separation membrane 12 is formed on the inner surface of each first cell 111a as an open cell (i.e., on the surface layer 33) and covers approximately the entire inner surface. The separation membrane 12 is a porous membrane having microscopic pores. The separation membrane 12 separates a specific substance from a mixture of substances including a plurality of types of substances. In the present embodiment, the separation membrane 12 has an approximately cylindrical shape.

The separation membrane 12 may preferably be an inorganic membrane formed of an inorganic material, may more preferably be any of a zeolite membrane, a silica membrane, a carbon membrane, and a metal-organic framework (MOF) membrane, and may particularly preferably be a zeolite membrane. That is, the separation membrane complex 1 may preferably be an inorganic membrane complex, may more preferably be any of a zeolite membrane complex, a silica membrane complex, a carbon membrane complex, and a MOF membrane complex, and may particularly preferably be a zeolite membrane complex. The zeolite membrane refers to at least a membrane obtained by forming a zeolite in membrane form on the surface of the support 11, and does not include a membrane obtained by only dispersing zeolite particles in an organic membrane. The same applies to the other inorganic membranes. In the present embodiment, the separation membrane 12 is a zeolite membrane. The separation membrane 12 may be a zeolite membrane that contains two or more types of zeolites having different structures or compositions.

The separation membrane 12 may have a thickness of, for example, greater than or equal to 0.05 μm and less than or equal to 50 μm, preferably greater than or equal to 0.1 μm and less than or equal to 20 μm, and more preferably greater than or equal to 0.5 μm and less than or equal to 10 μm. Increasing the thickness of the separation membrane 12 improves separation performance. Reducing the thickness of the separation membrane 12 increases permeance. The surface roughness (Ra) of the separation membrane 12 may, for example, be less than or equal to 5 μm, preferably less than or equal to 2 μm, more preferably less than or equal to 1 μm, and yet more preferably less than or equal to 0.5 μm. The pore diameter of the separation membrane 12 may be in the range of, for example, 0.2 nm to 1 nm. The pore diameter of the separation membrane 12 is smaller than the mean pore diameter in the surface layer 33 of the support 11.

In the case where the zeolite constituting the separation membrane 12 is composed of an n-membered ring at the maximum, the minor axis of the n-membered ring pore is assumed to be the pore diameter of the separation membrane 12. In the case where the zeolite includes a plurality of types of n-membered ring pores where n is the same number, the minor axis of an n-membered ring pore having a largest minor axis is assumed to be the pore diameter of the separation membrane 12. Note that the n-membered ring refers to a ring in which n oxygen atoms compose the framework of each pore and each oxygen atom is bonded to T atoms described later to form a cyclic structure. The n-membered ring also refers to a ring that forms a through hole (channel), and does not include a ring that does not form a through hole. The n-membered ring pore refers to a pore formed of an n-membered ring. From the viewpoint of improving selectivity, it is preferable that the zeolite constituting the zeolite membrane 12 may be composed of an 8- or less-membered ring (e.g., 6- or 8-membered ring) at the maximum.

The pore diameter of the separation membrane 12 is uniquely determined by the framework structure of the zeolite and can be obtained from values disclosed in “Database of Zeolite Structures” [online], by International Zeolite Association, Internet <URL:http://www.iza-structure.org/databases/>.

There are no particular limitations on the type of the zeolite constituting the separation membrane 12, and the zeolite may, for example, be an AEI-, AEN-, AFN-, AFV-, AFX-, BEA-, CHA-, DDR-, ERI-, ETL-, FAU-(X-type, Y-type), GIS-, IHW—, LEV-, LTA-, LTJ-, MEL-, MFI-, MOR-, PAU-, RHO—, SOD-, or SAT-type zeolite. In the case where the zeolite is an 8-membered ring zeolite, the zeolite may, for example, be an AEI-, AFN-, AFV-, AFX-, CHA-, DDR-, ERI-, ETL-, GIS-, IHW—, LEV-, LTA-, LTJ-, RHO—, or SAT-type zeolite. In the present embodiment, the zeolite constituting the separation membrane 12 is a DDR-type zeolite.

The zeolite constituting the separation membrane 12 may contain, for example, at least one of silicon (Si), aluminum (Al), and phosphorus (P) as T atoms (i.e., atoms located in the center of oxygen tetrahedron (TO₄) that constitutes the zeolite). The zeolite constituting the separation membrane 12 may, for example, be a zeolite in which T atoms are composed of only Si or of Si and Al, an AlPO-type zeolite in which T atoms are composed of Al and P, an SAPO-type zeolite in which T atoms are composed of Si, Al, and P, an MAPSO-type zeolite in which T atoms are composed of magnesium (Mg), Si, Al, and P, or a ZnAPSO-type zeolite in which T atoms are composed of zinc (Zn), Si, Al, and P. Some of the T atoms may be replaced by other elements. The zeolite constituting the separation membrane 12 may contain alkali metal. The alkali metal may, for example, be sodium (Na) or potassium (K).

In the case where the zeolite constituting the separation membrane 12 contains Si atoms and Al atoms, the Si/Al ratio in the zeolite of the separation membrane 12 may, for example, be higher than or equal to one and lower than or equal to a hundred thousand. The Si/Al ratio refers to the molar ratio of Si elements to Al elements contained in the zeolite of the separation membrane 12. The Si/Al ratio may preferably be higher than or equal to 5, more preferably higher than or equal to 20, and yet more preferably higher than or equal to 100. It is preferable that the Si/Al ratio is as high as possible because the separation membrane 12 can achieve higher resistance to heat and acids. The Si/Al ratio can be adjusted by adjusting, for example, the compounding ratio of an Si source and an Al source in a starting material solution, which will be described later.

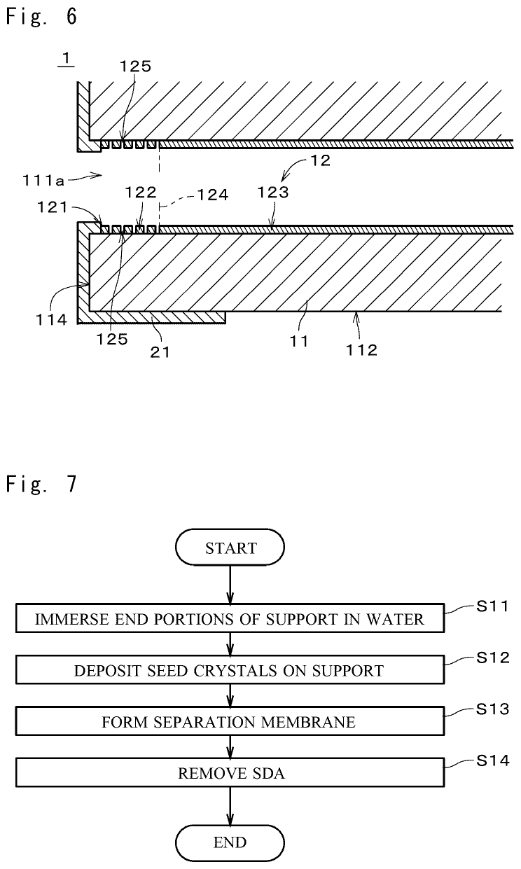

FIG. 5 is a sectional view showing the vicinity of one longitudinal end portion of a first cell 111a in the separation membrane complex 1 in enlarge dimensions. In the illustration of FIG. 5, the thickness of the separation membrane 12 is greater than the actual thickness, and the support 11, the separation membrane 12, and the sealer 21 are cross-hatched (the same applies to FIG. 6). The sealer 21 is a member that covers and seals the longitudinal end faces 114 of the support 11 and parts of the outer surface 112 in the vicinity of the longitudinal end faces 114 on both longitudinal sides of the separation membrane complex 1. For example, the sealer 21 may be a sealing layer formed of glass or a resin. The sealer 21 prevents the inflow and outflow of gas and liquid from and to the inside of the support 11.

In the following description, portions of the separation membrane 12 that are within a range of one-tenth of the longitudinal length of the separation membrane 12 from both longitudinal edges 121 of the separation membrane 12 on both longitudinal sides are referred to as “membranous end portion 122.” In other words, the membrane end protons 122 are approximately cylindrical portions that extend from the edges 121 of the separation membrane 12 toward the longitudinal central portion by a length corresponding to one-tenth of the longitudinal length of the separation membrane 12. In the example shown in FIG. 5, each edge 121 of the separation membrane 12 is located at approximately the same longitudinal position as the opening of each first cell 111a and the end face 114 of the support 11. Thus, the longitudinal length of the separation membrane 12 (i.e., the distance in the longitudinal direction between both of the edges 121 of the separation membrane 12) is approximately the same as the longitudinal length of the support 11. In the following description, a portion of the separation membrane 12 excluding the membranous end portions 122 on both longitudinal sides is referred to as a “membranous central portion 123.” In FIG. 5, a boundary 124 between one membranous end portion 122 and the membranous central portion 123 of the separation membrane 12 is indicated by the chain double-dashed line.

In the example shown in FIG. 5, the sealer 21 covers a portion of the end face 114 of the support 11 excluding the opening of the first cell 111a and a portion of the outer surface 112 of the support 11 that is located in the vicinity of the end face 114, and substantially the sealer 21 does not cover the inner surface of the first cell 111a. On the outer surface 112 of the support 11, the sealer 21 spreads in approximately cylindrical form in the longitudinal direction from the end face 114 of the support 11 and extends toward the center in the longitudinal direction over the boundary 124 between the membranous end portion 122 and the membranous central portion 123.

In other words, in the regions of the support 11 where the membranous end portions 122 are arranged, the sealer 21 covers the outer surface 112 that is the surface of the support 11 on the side opposite to the surface thereof that is in contact with the membranous end portion 122 (i.e., the inner surface of the first cell 111a). On the outer surface 112 of the support 11, the sealer 21 extends from the position facing the membranous end portion 122 with the support 11 in between to the position facing the membranous central portion 123 with the support 11 sandwiched in between. In yet other words, the sealer 21 covers whole regions of the outer surface 112 of the support 11 that overlap the membranous end portions 122 in the radial direction about the central axis of the separation membrane complex 1 (i.e., a virtual straight line extending in the longitudinal direction through the centers of the end faces 114 of the separation membrane 1) and covers part of regions that overlap the membranous central portion 123 in the radial direction (i.e., regions in the vicinity of the boundaries 124 in the longitudinal direction).

FIG. 6 is a sectional view of the separation membrane complex 1 and shows the vicinity of one longitudinal end portion of a first cell 111a in enlarged dimensions. The example shown in FIG. 6 is approximately the same as the example shown in FIG. 5, except that the sealer 21 further extends to the inner surface of the first cell 111a. The sealer 21 shown in FIG. 6 covers the portion of the end face 114 of the support 11 excluding the opening of the first cell 111 and the portion of the outer surface 112 of the support 11 that is located in the vicinity of the end face 114 in the same manner as described in the example shown in FIG. 5. On the outer surface 112 of the support 11, the sealer 21 spreads in approximately cylindrical form in the longitudinal direction from the end face 114 of the support 11 and extends toward the center in the longitudinal direction over the boundary 124 between the membranous end portion 122 and the membranous central portion 123.

On the inner surface of the first cell 111a, the sealer 21 slightly spreads in approximately cylindrical form in the longitudinal direction from the end face 114 of the support 11 so as to have contact with the separation membrane 12. On the inner surface of the first cell 111a, the boundary between the sealer 21 and the separation membrane 12 corresponds to the longitudinal edge 121 of the separation membrane 12. In the longitudinal direction, the edge 121 of the separation membrane 12 is located between the end face 114 of the support 11 and the edge of the sealer 21 on the outer surface 112 of the support 11 (i.e., the edge on the side opposite to the end face 114 of the support 11). In the example shown in FIG. 6 the longitudinal length of the separation membrane 12 (i.e., the distance in the longitudinal direction between both edges 121 of the separation membrane 12) is slightly shorter than the longitudinal length of the support 11.

The separation membranes 12 shown in FIGS. 5 and 6 have defects 125 of a predetermined degree that are intentionally formed in the membranous end portions 122 at the time of forming the separation membrane 12 on the support 11 by, for example, a method of producing the membranous end portion 122, which will be described later. In the illustration of FIGS. 5 and 6, the defects 125 are larger than the actual size. In the illustration of FIGS. 5 and 6, although there are a plurality of defects 125 that are dispersed in the membranous end portions 122 approximately uniformly in the longitudinal direction, the number, arrangement, and size of the defects 125 may be modified in various ways.

The defects 125 are holes (e.g., gaps between grain boundaries or cracks) that are significantly larger than the pores of the separation membrane 12 described above. In the case where the separation membrane complex 1 is used for the separation of a mixed gas, the pores of the separation membrane 12 allow a gas having permeability (hereinafter, also referred to as a “high-permeability gas”) in the mixed gas to pass therethrough, but substantially do not allow a gas having low permeability (hereinafter, also referred to as a “low-permeability gas”) to pass therethrough. On the other hand, the defects 125 allow not only a high-permeability gas but also a low-permeability gas in the mixed gas to pass therethrough. The defects 125 are not intentionally formed in the membranous central portion 123 of the separation membrane 12.

For example, in the case where a CF₄ gas is used as a low-permeability gas, average CF₄ permeance of one longitudinal membranous end portion 122 is higher than or equal to 5 times or more and 100 times or less of average CF₄ permeance of the membranous central portion 123, and may preferably be 5 times or more and 50 times or less thereof. Similarly, average CF₄ permeance of the other longitudinal membranous end portion 122 is higher than or equal to 5 times or more and 100 times or less of the average CF₄ permeance of the membranous central portion 123, and may preferably be higher than or equal to 5 times or more and 50 times or less thereof. The average permeance of each membranous end portion 122 refers to an average value of the permeance at each position in the whole membranous end portion 122. The average permeance of the membranous central portion 123 refers to an average value of the permeance at each position in the whole membranous central portion 123.

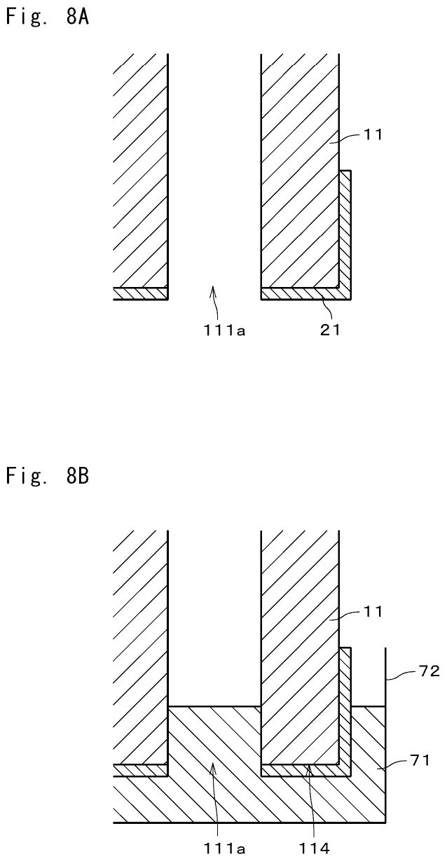

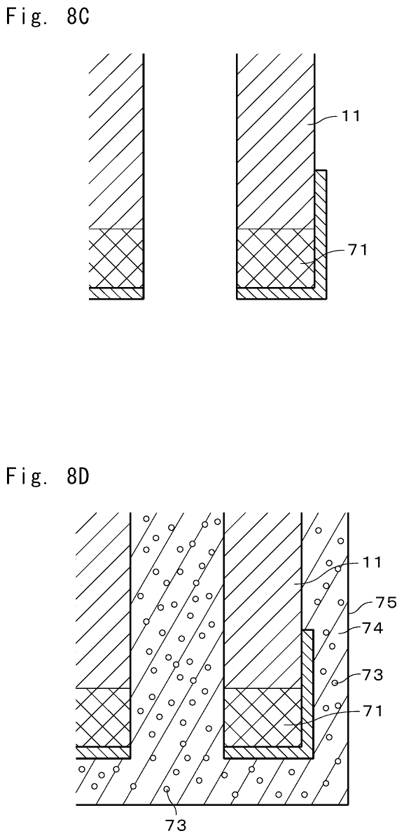

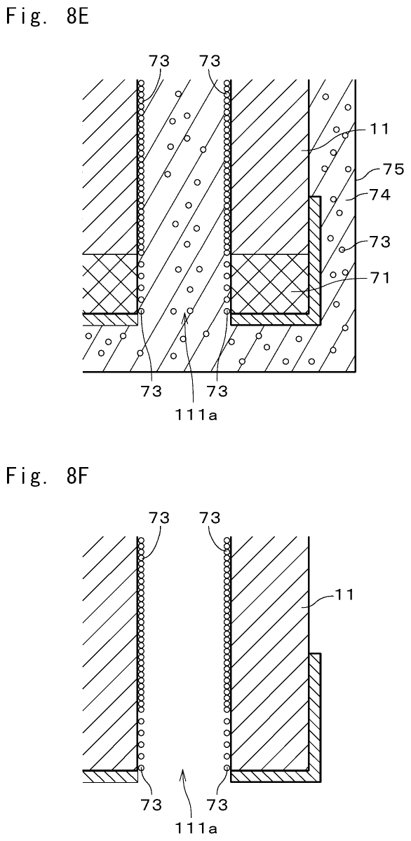

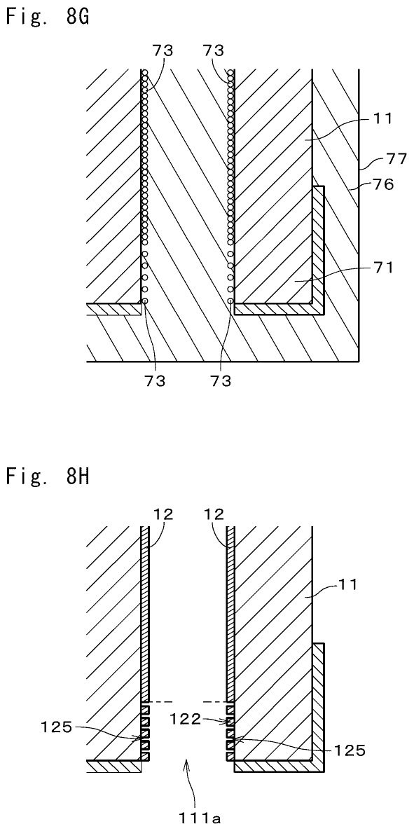

Next, one example of the procedure for the production of the separation membrane complex 1 will be described with reference to FIG. 7 and FIGS. 8A to 8H. FIG. 7 is a flowchart showing the production of the separation membrane complex 1. FIGS. 8A to 8H are sectional views showing part of the separation membrane complex 1 in the process of being produced. FIGS. 8A to 8H show the vicinity of one longitudinal end portion of a first cell 111a in enlarged dimensions and conceptually shows the section thereof in a simplified manner in order to facilitate understanding of the drawings.

In the production of the separation membrane complex 1, firstly, the support 11 having longitudinal end portions formed with the sealer 21 is prepared as shown in FIG. 8A. In the example shown in FIG. 8A, the sealer 21 has the same shape as that shown in FIG. 5, and the sealer 21 is not formed on the inner surface of the first cell 111a.

Then, as shown in FIG. 8B, one longitudinal end portion of the support 11 is brought into contact with a pre-processing liquid 71 (step S11). The other longitudinal end portion of the support 11 is also brought into contact with the pre-processing liquid 71 in the same manner. The contact of the support 11 with the pre-processing liquid 71 may be made by, for example, immersing the longitudinal end portions of the support 11 in the pre-processing liquid 71 stored in a container 72. The pre-processing liquid 71 is a liquid for forming the defects 125 in the aforementioned membranous end portions 122 and may, for example, be water. The pre-processing liquid 71 may be a liquid other than water as long as the liquid has a lower concentration of seed crystals than a dispersion described later in which seed crystals are dispersed. The concentration of seed crystals in the pre-processing liquid 71 may preferably be lower than or equal to 50% of the concentration of seed crystals in the dispersion, may more preferably be lower than or equal to 20%, may particularly preferably be lower than or equal to 10%, and may be 0%. This facilitates control of the density of seed crystals deposited on the end portions of the support 11 in step S12 described later. For example, a solvent in the pre-processing liquid 71 may be water or alcohol such as ethanol. The solvent in the pre-processing liquid 71 may be any other liquid.

The end portions of the support 11 that are brought into contact with the pre-processing liquid 71 in step S11 are portions that are within a range of one-tenth or less of the longitudinal length of the support 11 from the longitudinal edges of the support 11 (i.e., the end faces 114). Note that the longitudinal length of the aforementioned end portions, which are brought into contact with the pre-processing liquid 71, may preferably be within a range of 1/15 or less of the longitudinal length of the support 11 and more preferably within a range of 1/20 or less. By so doing, it is possible to form the defects 125 in the end portions closer to the ends of the support 11 and to allow the mixed gas passing the defects 125 and flowing to the permeate side to more efficiently act as a sweep gas in step 22 described later. In step S11, the pre-processing liquid 71 adheres to the whole or part of regions of the inner surfaces of the first cells 111a on which the membranous end portions 122 are to be placed in the subsequent step. Thereafter, the support 11 is taken out of the container 72 storing the pre-processing liquid 71. As shown in FIG. 8C, the support 11 taken out of the container 72 keeps hold of the pre-processing liquid 71 with which the pores in the longitudinal end portions of the support 11 are impregnated. In FIG. 8C, portions of the support 11 that are impregnated with the pre-processing liquid 71 are cross-hatched in a different manner from the other portions. Note that the contact of the support 11 with the pre-processing liquid 71 in step S11 may be made by a method other than immersion.

Next, as shown in FIGS. 8D and 8E, the support 11 is brought into a dispersion 74 in which seed crystals 73 (i.e., seed crystals of a zeolite) used for the formation of the separation membrane 12 are dispersed in a solvent, so as to deposit the seed crystals 73 on the support 11 (step S12). In the illustrations of FIGS. 8D and 8E, the seed crystals 73 are larger than the actual size (the same applies to FIGS. 8F and 8G).

The contact of the support 11 with the dispersion 74 may be made by, for example, immersing the support 11 in the dispersion 74 stored in a container 75. In step S12, portions of the surface of the support 11 excluding the inner surfaces of the first cells 111a are covered with a resin film or the like (not shown). Thus, the seed crystals are deposited on only the inner surfaces of the first cells 111a out of the surface of the support 11. Note that the seed crystals may be deposited on the inner surfaces of the first cells 111a by any other method.

The dispersion 74 is prepared by dispersing the seed crystals 73 in advance in a solvent (e.g., water or alcohol such as ethanol). The solvent in the dispersion 74 may be the same as or different from the solvent in the pre-processing liquid 71. For example, the seed crystals 73 may be produced in advance through the following procedure. In the production of the seed crystals 73, firstly, a starting material solution of the seed crystals are prepared by dissolving or dispersing, for example, a starting material such as an Si source and a structure-directing agent (hereinafter, also referred to as an “SDA”) in a solvent. Then, the starting material solution is subjected to hydrothermal synthesis, and resultant crystals are washed and dried so as to obtain zeolite powder. The zeolite powder may be used as-is as the seed crystals 73, or may be subjected to processing such as pulverization to obtain the seed crystals 73.

In step S12, the pre-processing liquid 71 is deposited in advance to the longitudinal end portions of the support 11 that are immersed in the dispersion 74. Thus, as shown in FIG. 8E, the density of the seed crystals 73 deposited on the inner surface of the first cell 111a in the end portions of the support 11 becomes lower than the density of the seed crystals 73 deposited on the inner surface of the first cell 111a in the other portions of the support 11 (i.e., portions on which the pre-processing liquid 71 is not deposited) other than the end portions.

When step S12 has ended, the support 11 is taken out of the container 75 storing the dispersion 74 and dried. Accordingly, as shown in FIG. 8F, a seed-crystal-deposited support is obtained in which the seed crystals 73 are deposited on the inner surfaces of the first cells 111a. In the seed-crystal-deposited support, the density of the seed crystals 73 deposited on the inner surfaces of the first cells 111a in the longitudinal end portions of the support 11 is also lower than the density of the seed crystals 73 deposited on the inner surfaces of the first cells 111a in the other portions of the support 11 excluding than the end portions.

Then, as shown in FIG. 8G, the support 11 with the seed crystals 73 deposited thereon is immersed in a starting material solution 76 stored in a container 77. The starting material solution 76 may be prepared in advance by dissolving, for example, an Si source and an SDA in a solvent. The solvent in the starting material solution may, for example, be water or alcohol such as ethanol. The SDA contained in the starting material solution may, for example, be an organic compound. For example, 1-adamantanamine may be used as the SDA.

Then, a zeolite is grown by hydrothermal synthesis using the seed crystals 73 as nuclei so as to form a zeolite membrane as the separation membrane 12 on the inner surfaces of the first cells 111a of the support 11 as shown in FIG. 8H (step S13). The temperature during the hydrothermal synthesis may preferably be in the range of 120° C. to 200° C. and may, for example, be 160° C. The hydrothermal synthesis time may preferably be in the range of 5 hours to 100 hours and may, for example, be 30 hours. The separation membrane 12 formed in step S13 has the aforementioned defects 125 formed in the longitudinal end portions having a lower deposit density of the seed crystals 73 (i.e., portions included in the membranous end portions 122), and has no defects 125 intentionally formed in the other portions excluding the end portions.

When the hydrothermal synthesis has ended, the support 11 and the zeolite membrane 12 are washed with deionized water. After washing, the support 11 and the zeolite membrane 12 are dried at, for example, 80° C. After the drying of the support 11 and the zeolite membrane 12, the zeolite membrane 12 is subjected to heat treatment (i.e., firing) so as to almost completely remove the SDA in the zeolite membrane 12 by combustion and to perforate the zeolite membrane 12 with micropores. In this way, the aforementioned separation membrane complex 1 is obtained (step S14). In the separation membrane complex 1 obtained in step S14, as described above, the defects 125 are formed in the longitudinal end portions of the separation membrane 12 (i.e., portions included in the membranous end portions 122), and the defects 125 are not intentionally formed in the other portions of the separation membrane 12 excluding the end portions. In the production of the separation membrane complex 1, the sealer 21 may be formed after the formation of the separation membrane 12.

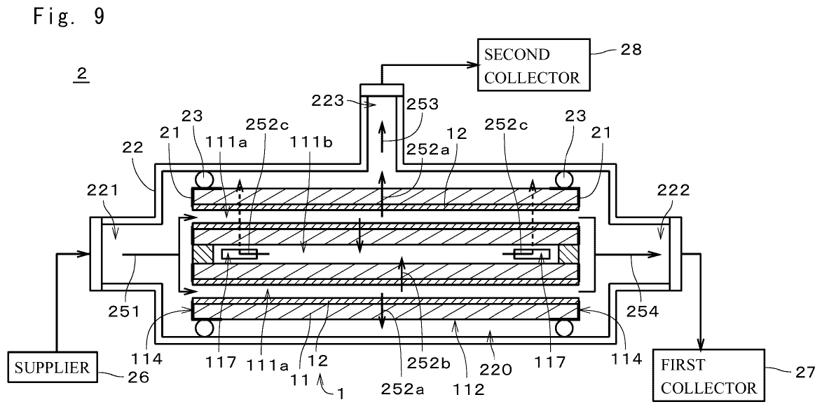

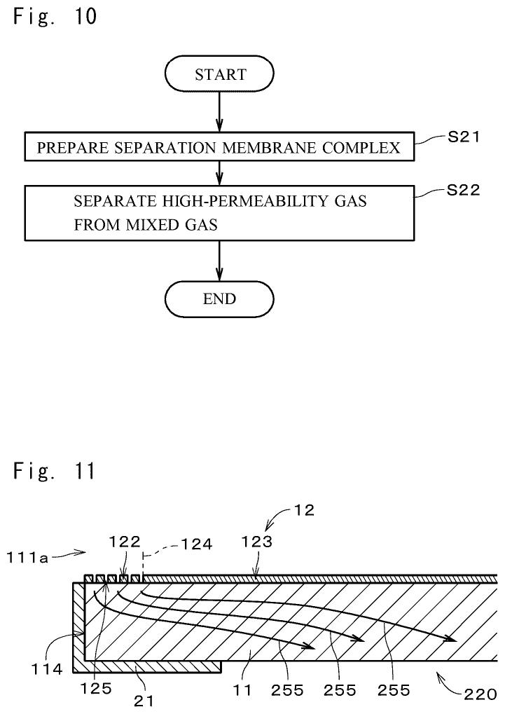

Next, the separation of a mixed gas using the separation membrane complex 1 will be described with reference to FIGS. 9 and 10. FIG. 9 is a sectional view showing the mixed gas separation apparatus 2 (hereinafter, also simply referred to as the “separation apparatus 2”). To facilitate understanding of the drawing, FIG. 9 conceptually shows a section of the separation membrane complex 1 in a simplified manner. FIG. 10 is a flowchart showing the separation of a mixed gas using the separation apparatus 2.

The separation apparatus 2 supplies a mixed gas containing a plurality of types of gases to the separation membrane complex 1 and separates a high-permeability gas in the mixed gas from the mixed gas by allowing the high-permeability gas to permeate the separation membrane complex 1. The separation by the separation apparatus 2 may be performed, for example, for the purpose of extracting a high-permeability gas from the mixed gas or for condensing a low-permeability gas.

The mixed gas may contain, for example, one or more types of substances among hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluoride, mercury (Hg), arsine (AsH₃), hydrogen cyanide (HCN), carbonyl sulfide (COS), C1 to C8 hydrocarbons, organic acids, alcohol, mercaptans, ester, ether, ketone, and aldehyde. The aforementioned high-permeability gas may, for example, be one or more types of substances among Co₂, NH₃, and H₂O. Note that the mixed gas and the high-permeability gas may be substances other than those described above.

Nitrogen oxides are compounds of nitrogen and oxygen. For example, the aforementioned nitrogen oxides may be substances called NOₓ such as nitrogen monoxide (NO), nitrogen dioxide (NO₂), nitrous oxide (also referred to as nitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be substances called SOₓ such as sulfur dioxide (SO₂) or sulfur trioxide (SO₃).

Sulfur fluoride is a compound of fluorine and sulfur. For example, the aforementioned sulfur fluoride may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either a saturated hydrocarbon (i.e., where double bonds and triple bonds are not located in molecules) or an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃ (CH₂)₂CH₃), isobutene (CH(CH₃)₃), 1-butene (CH₂—CHCH₂CH₃), 2-butene (CH₃CH═CHCH₃), or isobutene (CH₂—C(CH₃)₂).

The aforementioned organic acids may, for example, be carboxylic acids or sulfonic acids. The carboxylic acids may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acids may, for example, be ethane sulfonic acid (C₂H₆O₃S). The organic acids may be either chain compounds or cyclic compounds.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with terminal sulfur hydrides (SH) and are also substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), diethyl ether ((C₂H₅)₂O), or tetrahydrofuran ((CH₂)₄O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

As shown in FIG. 9, the separation apparatus 2 includes the separation membrane complex 1, the sealer 21, a housing 22, and two seal members 23. The sealer 21 may be assumed to be included in the separation membrane complex 1. The separation membrane complex 1, the sealer 21, and the seal members 23 are placed in the housing 22. In FIG. 9, the separation membrane 12 of the separation membrane complex 1 is cross-hatched. The internal space of the housing 22 is an enclosed space isolated from the space around the housing 22. The housing 22 is connected to a supplier 26, a first collector 27, and a second collector 28.

The sealer 21 is a member that is attached to both end portions in the longitudinal direction of the support 11 (i.e., the left-right direction in FIG. 9) and covers and seals both of the longitudinal end faces 114 of the support 11 and part of the outer surface 112 in the vicinity of these end faces 114 as described above. In the present embodiment, the sealer 21 is a glass seal having a thickness of 10 μm to 50 μm. The material and shape of the sealer 21 may be changed as appropriate. Note that the sealer 21 has a plurality of openings that overlap the plurality of first cells 111a of the support 11, so that both longitudinal ends of each first cell 111a are not covered with the sealer 21. This allows the inflow and outflow of fluid from both of the longitudinal ends into and out of the first cell 111a.

The housing 22 is an approximately cylindrical tube-like member. For example, the housing 22 may be made of stainless steel or carbon steel. The longitudinal direction of the housing 22 is approximately parallel to the longitudinal direction of the separation membrane complex 1. One longitudinal end of the housing 22 (i.e., the end on the left side in FIG. 9) is provided with a supply port 221, and the other longitudinal end thereof is provided with a first exhaust port 222. The supply port 221 is connected to the supplier 26. The first exhaust port 222 is connected to the first collector 27. The housing 22 further has a second exhaust port 223 on the side. The second exhaust port 223 is connected to the second collector 28. Note that the shape and material of the housing 22 may be changed variously.

The two seal members 23 are placed between the outer surface 112 of the separation membrane complex 1 and the inner surface of the housing 22 in the vicinity of both longitudinal end portions of the separation membrane complex 1. In each longitudinal end portion of the separation membrane complex 1, the seal member 23 is located between the end face 114 and a slit 117 of the separation membrane complex 1 in the longitudinal direction. Each seal member 23 is an approximately circular ring-shaped member formed of a material that is impermeable to gas and liquid. For example, the seal members 23 may be O-rings or packing materials formed of a resin having flexibility.

The seal members 23 are in tight contact with the outer surface 112 of the separation membrane complex 1 and the inner surface of the housing 22 along the entire circumference in the circumferential direction about the aforementioned central axis of the separation membrane complex 1 (hereinafter, also simply referred to as the “circumferential direction”). In the example shown in FIG. 9, the seal members 23 are in tight contact with the outer surface of the sealer 21 and are indirectly in tight contact with the outer surface 112 of the separation membrane complex 1 via the sealer 21. Note that the seal members 23 may be directly in tight contact with the outer surface 112 of the separation membrane complex 1. The space between each seal member 23 and either the outer surface 112 of the separation membrane complex 1 or the sealer 21 and the space between each seal member 23 and the inner surface of the housing 22 are sealed so as to substantially disable the passage of gas and liquid. Note that the material for the seal members 23 may be carbon, metal, or any other inorganic material other than a resin.

The supplier 26 supplies a mixed gas into the internal space of the housing 22 via the supply port 221. For example, the supplier 26 may include a pressure mechanism such as a blower or a pump that sends the mixed gas toward the housing 22 under pressure. The pressure mechanism may include, for example, a temperature controller and a pressure regulator that respectively adjust the temperature and pressure of the mixed gas supplied to the housing 22. The first collector 27 and the second collector 28 may include, for example a reservoir that stores the gas derived from the housing 22, or a blower or a pump that transfers the derived gas.

In the separation of a mixed gas, firstly, the separation membrane complex 1 is prepared (step S21 in FIG. 10). Specifically, the separation membrane complex 1 is attached to the inside of the housing 22. Then, the supplier 26 supplies a mixed gas containing a plurality of types of gases with different permeability through the separation membrane 12, into the housing 22 (specifically, the space on the left side of the left end face 114 of the separation membrane complex 1) as indicated by an arrow 251 in FIG. 9. For example, the mixed gas may be composed primarily of CO₂ and CH₄. The mixed gas may further contain a gas other than CO₂ and CH₄. The pressure of the mixed gas supplied from the supplier 26 into the housing 22 (i.e., initial pressure) may be in the range of, for example, 0.1 MPa to 20.0 MPa. The temperature of the mixed gas supplied from the supplier 26 may be in the range of, for example, 10° C. to 250° C.

The mixed gas supplied from the supplier 26 into the housing 22 flows into each first cell 111a of the separation membrane complex 1. As indicated by arrows 252a, a gas having high permeability in the mixed gas, i.e., a high-permeability gas, permeates the separation membrane 12 and the support 11 from the first cells 111a and is derived to a separation space 220 from the outer surface 112 of the separation membrane complex 1. The high-permeability gas having permeated the separation membrane 12 and the support 11 from the first cells 111a and flowed into the second cells 111b as indicated by arrows 252b flows through the slits 117 to the separation space 220 as indicated by arrows 252c. Note that the high-permeability gas flowing from the first cells 111a into the second cells 111b may permeate the support and be derived to the separation space 220 without passing through the slits 117.

FIG. 11 is a sectional view showing the vicinity of one longitudinal end portion of a first cell 111a in enlarged dimensions. In the separation membrane complex 1, the defects 125 are formed in the membranous end portions 122 of the separation membrane 12 as described above. As shown in FIG. 11, the mixed gas supplied to the first cell 111a flows through the defects 125 to the permeate side of the separation membrane 12 (i.e., the side opposite to the internal space of the first cell 111a), flows through the pores of the support 11 along the membranous central portion 123 as indicated by arrows 255, and further flows toward the separation space 220. Accordingly, the high-permeability gas that has permeated the membranous central portion 123 of the separation membrane 12 from the first cells 111a is carried by the mixed gas flowing from the membranous end portions 122 to the permeate side and speedily derived to the separation space 220. That is, the mixed gas flowing out from the membranous end portions 122 to the permeate side acts as a sweep gas that flows on the permeate side of the separation membrane 12. This lowers the partial pressure of the high-permeability gas on the permeate side of the separation membrane 12 and accelerates the permeation of the high-permeability gas from the feed side of the separation membrane 12 (i.e., the internal spaces of the first cells 111a) to the permeate side.

As described above, the sealer 21 extends from the position facing the membranous end portions 122 with the support 11 sandwiched in between to the position facing the membranous central portion 123 with the support 11 sandwiched in between. In other words, the sealer 21 extends toward the center in the longitudinal direction over the boundaries 124 between the membranous end portions 122 and the membranous central portion 123. This inhibits the mixed gas flowing to the permeate side through the defects 125 of the membranous end portions 122 from immediately flowing toward the separation space 220 and accordingly increases the distance by which the mixed gas flows along the membranous central portion 123. As a result, the mixed gas can more favorably act as the sweep gas, and the flow of the high-permeability gas from the feed side of the separation membrane 12 to the permeate side is further accelerated.

In the separation apparatus 2 shown in FIG. 9, as a result of the high-permeability gas (e.g., CO₂) permeating the separation membrane 12 and being derived to the separation space 220 as described above, the high-permeability gas is separated from other substances such as a low-permeability gas (e.g., N₂) in the mixed gas (step S22). Since the end faces 114 of the support 11 are covered with the sealer 21 as described above, the separation membrane complex 1 prevents or inhibits the mixed gas containing a low-permeability gas from entering the inside of the support 11 through the end faces 114 and entering the separation space 220 without permeating the separation membrane 12.

The gas derived to the separation space 220 (hereinafter, referred to as the “permeated gas”) is guided to and collected by the second collector 28 via the second exhaust port 223 as indicated by an arrow 253 in FIG. 9. The second collector 28 serves as a permeated gas collector that collects the permeated gas having permeated the separation membrane 12 in the mixed gas. The permeated gas may include a low-permeability gas that has permeated the separation membrane 12, in addition to the aforementioned high-permeability gas.

In the mixed gas, a gas excluding the gas that has permeated the separation membrane 12 and the support 11 (hereinafter, referred to as a “non-permeated gas”) flows from the left side to the right side in FIG. 9 through the first cells 111a and is guided to and collected by the first collector 27 via the first exhaust port 222 as indicated by an arrow 254. The first collector 27 serves as a non-permeated gas collector that collects a non-permeated gas that has not permeated the separation membrane 12 in the mixed gas. The non-permeated gas collected by the first collector 27 may include a high-permeability gas that has not permeated the separation membrane 12, in addition to the aforementioned low-permeability gas. For example, the non-permeated gas collected by the first collector 27 may be circulated to the supplier 26 and supplied again into the housing 22.

Next, performance of the separation membrane complexes 1 in Examples 1 to 3 and Comparative Examples 1 and 2 will be described with reference to Table 1.

TABLE 1

| | End Permeance | Denseness of | CO₂ Recovery Rate |
|---|---|---|---|
| | Ratio | Membrane | (%) |
| Example 1 | 49.6 | ⊚ | 67.1 |
| Example 2 | 5.2 | ⊚ | 50.2 |
| Example 3 | 98.0 | ◯ | 77.4 |
| Comparative | 1.2 | ⊚ | 43.7 |
| Example 1 | | | |
| Comparative | 903.5 | X | — |
| Example 2 | | | |

In Example 1, the separation membrane complex 1 was prepared by a production method similar to the method including steps S11 to S14 described above. In step S11, portions of the support 11 that are within a range of 10 mm from the end faces 114 on both longitudinal sides of the support 11 were immersed in water as the pre-processing liquid 71 for one minute. The support 11 had an outside diameter of 30 mm, and the support 11 and the separation membrane 12 had a length of 160 mm. The separation membrane 12 formed on each first cell 111a was a DDR-type zeolite membrane. Each first cell 111a had an inside diameter of 2.0 mm.

In Example 1, the denseness of the separation membrane 12 before removal of the SDA was evaluated between step S13 and step S14. In this evaluation, the separation membrane complex 1 before the removal of the SDA was attached to the inside of the housing 22 of the separation apparatus 2, and an N₂ gas (single component gas) was supplied from the supplier 26. Then, the amount of N₂ gas collected by the second collector 28 was measured to obtain N₂ permeance (nmol/m²·s·Pa). In Table 1, cases in which the N₂ permeance was lower than 0.005 nmol/m²·s. Pa are marked with a double circle (excellent), cases in which the N₂ permeance was higher than or equal to 0.005 nmol/m²·s·Pa and lower than 0.01 nmol/m²·s. Pa are marked with an open circle (good), cases in which the N₂ permeance was higher than or equal to 0.01 nmol/m²·s·Pa and lower than 0.05 nmol/m²·s. Pa are marked with a triangle (moderate), and cases in which the N₂ permeance was higher than or equal to 0.05 nmol/m²·s·Pa are marked with a cross (poor).

In Example 1, a CO₂ separation test was conducted after step S14. In the CO₂ separation test, the separation membrane complex 1 after the removal of the SDA was attached to the inside of the housing 22 of the separation apparatus 2, and a mixed gas that contained 10% by volume of CO₂ gas and 90% by volume of N₂ gas was supplied from the supplier 26. The pressure of the mixed gas supplied from the supplier 26 to the inside of the housing 22 was assumed to be 1 MPa, and the flow rate was assumed to be 20 NL/min. The pressure of the permeated gas collected by the second collector 28 was assumed to be atmospheric pressure. Then, the CO₂ concentration and the flow rate of the permeated gas collected by the second collector 28 were measured to obtain a CO₂ recovery rate.

In Example 1, the ratio of average CF₄ permeance of the membranous end portions 122 to the average CF₄ permeance of the membranous central portion 123 (hereinafter, also referred to as the “end permeance ratio”) was also obtained. Specifically, the separation membrane complex 1 after the removal of the SDA was attached to the inside of the housing 22 of the separation apparatus 2, and a CF₄ gas (single component gas) was supplied from the supplier 26. The pressure of the CF₄ gas supplied from the supplier 26 to the inside of the housing 22 was assumed to be 0.4 MPa. The pressure of the permeated gas collected by the second collector 28 was assumed to be atmospheric pressure. Then, the amount of CF₄ gas collected by the second collector 28 was measured to obtain the CF₄ permeance. This permeance was average permeance of the separation membrane 12 as a whole (i.e., an average value of permeance at each position in the separation membrane 12 as a whole) and hereinafter also referred to as “overall permeance.”

Then, the entire inner surfaces of the membranous end portions 122 of the separation membrane 12 (i.e., the surfaces on the side opposite to the support 11) on both longitudinal sides of the separation membrane complex 1 was sealed with the coating membrane in order to substantially disable the gas permeation. The coating membrane was a thin membranous member having a fine layered structure consist of a laminated inorganic compound. For example, the coating membrane may be made of a clay mineral such as smectite. The membranous end portions 122 refer to the portions of the separation membrane 12 that were within a range of 16 mm from the end faces 114 of the support 11.

Then, in the same manner as in the case of obtaining the overall permeance, the separation membrane complex 1 including the sealed membranous end portions 122 was attached to the inside of the housing 22 of the separation apparatus 2, and a CF₄ gas was supplied from the supplier 26 to obtain CF₄ permeance. This permeance was average permeance of the membranous central portion 123 as a whole and hereinafter also referred to as “membranous central permeance.” Thereafter, the overall permeance and the membranous central permeance were used to obtain average permeance of the membranous end portions 122 as a whole, i.e., “membranous end permeance,” and the membranous end permeance was divided by the membranous central permeance to obtain the end permeance ratio.

In Example 1, the end permeance ratio was 49.6 times, the denseness of the separation membrane 12 was evaluated as “excellent (marked with a double circle),” and the CO₂ recovery rate was 67.1%. The CO₂ recovery rate may preferably be 50% or higher, and the CO₂ recovery rate in Example 1 was high.

In Examples 2 and 3 and Comparative Examples 1 and 2, the separation membrane complex 1 was obtained in accordance with a procedure approximately similar to the procedure in Example 1, except for change described below, and the performance of the separation membrane complex 1 was also evaluated in accordance with a procedure similar to the procedure in Example 1.

In Example 2, the duration of time in which the support 11 was immersed in water in step S11 was changed to 0.2 minutes. In Example 2, the end permeance ratio was 5.2 times, the denseness of the separation membrane 12 was evaluated as “excellent (marked with a double circle),” and the CO₂ recovery rate was 50.2% and high.

In Example 3, the duration of time in which the support 11 was immersed in water in step S11 was changed to two minutes. In Example 3, the end permeance ratio was 98.0 times, the denseness of the separation membrane 12 was evaluated as “good (marked with an open circle),” and the CO₂ recovery rate was 77.4% and high.

In Comparative Example 1, the immersion of the support 11 in water in step S11 was omitted. Accordingly, in Comparative Example 1, the seed crystals were excessively deposited on regions of the support 11 on which the membranous end portions 122 were to be formed, and this resulted in a shortage of the defects 125 formed in the membranous end portions 122. Thus, the end permeance ratio was 1.2 times and low. The denseness of the separation membrane 12 was evaluated as “excellent (marked with a double circle),” and the CO₂ recovery rate was 43.7% and low.

In Comparative Example 2, the immersion of the support 11 in water in step S11 was omitted, and the end portions of the support 11 on which the seed crystals had been deposited were immersed in water for the application of ultrasound between step S12 and step S13. Accordingly, in Comparative Example 2, the seed crystals were removed at an excessive rate from the regions of the support 11 on which the membranous end portions 122 were to be formed, and the denseness of the separation membrane 12 was evaluated as “poor (marked with a cross).” In Comparative Example 2, the end permeance ratio was 903.5 times and excessively high. Note that the CO₂ recovery rate was not measured in Comparative Example 2 because of the extremely low denseness of the separation membrane 12.

Comparison between Examples 1 to 3 and Comparative Example 1 reveals that the end permeance ratio may preferably be five times or more from the viewpoint of increasing the CO₂ recovery rate (e.g., increasing the CO₂ recovery rate to 50% or higher).

Comparison between Examples 1 to 3 and Comparative Example 2 reveals that the end permeance ratio may preferably be 100 times or less from the viewpoint of securing the denseness of the separation membrane 12.

Comparison of Examples 1 to 3 further reveals that the end permeance ratio may preferably be 50 times or less from the viewpoint of improving the denseness of the separation membrane 12.

As described above, the separation membrane complex 1 includes the porous support 11 and the separation membrane 12 formed on the support 11. In the separation membrane complex 1, the average CF₄ permeance of the membranous end portions 122 is 5 times or more and 100 times or less of the average CF₄ permeance of the membranous central portion 123, where the membranous end portions 122 are the portions of the separation membrane 12 that are within a range of one-tenth of the longitudinal length of the separation membrane 12 from both longitudinal edges of the separation membrane 12, the membranous central portion 123 is the portion of the separation membrane 12 other than the membranous end portions 122 on both of the longitudinal sides.

In this way, when the end permeance ratio of one membranous end portion 122 in the longitudinal direction is set to be 5 times or more and 100 times or less, it is possible, as described above, to secure the denseness of the separation membrane 12 and to allow the gas flowing from the one membranous end portion 122 to the permeate side to favorably act as a sweep gas flowing on the permeate side of the separation membrane 12. As a result, the separation membrane complex 1 can achieve improved separation performance. Note that the aforementioned gas flowing from the membranous end portion 122 to the permeate side includes the mixed gas that has permeated the defects 125 or the like of the membranous end portion 122 and the high-permeability gas that has permeated the zeolite membrane in the membranous end portion 122. The same applies to the following description.

Preferably, the average CF₄ permeance of the above one membranous end portion 122 is 5 times or more and 50 times or less of the average CF₄ permeance of the membranous central portion 123. This improves the denseness of the separation membrane 12.

As described above, the average CF₄ permeance of the other membranous end portion 122 may preferably be 5 times or more and 100 times or less of the average CF₄ permeance of the membranous central portion 123. In this way, when the end permeance ratios of the membranous end portions 122 are set to be 5 times or more and 100 times or less on both the upstream and downstream sides of the flow of the mixed gas in the first cells 111a, it is possible to further improve the separation performance of the separation membrane complex 1. Specifically, when the gas flowing out from the upstream membranous end portion 122 to the permeate side acts as a sweep gas on the upstream side on which the high-permeability gas in the mixed gas has a relatively high partial pressure, it is possible to favorably accelerate the permeation of the high-permeability gas in the upstream portion of the membranous central portion 123 and to increase the amount of the high-permeability gas that permeates the separation membrane 12. Moreover, when the gas flowing from the downstream membranous end portion 122 to the permeate side acts as a sweep gas on the downstream side on which the high-permeability gas in the mixed gas has a relatively low partial pressure, it is possible to allow the separation membrane 12 to favorably act also in the downstream portion of the membranous central portion 123 and to increase the amount of the high-permeability gas that permeates the separation membrane 12.

More preferably, the average CF₄ permeance of the aforementioned other membranous end portion 122 may be 5 times or more and 50 times or less of the average CF₄ permeance of the membranous central portion 123. This further improves the denseness of the separation membrane 12.

As described above, preferably, the sealer 21 that covers and seals the surface of the support 11 on the side opposite to the surface thereof that is in contact with the aforementioned one membranous end portion 122 is placed in the region of the support 11 where the one membranous end portion 122 is arranged. Preferably, the sealer 21 may extend from the position facing the one membranous end portion 122 with the support 11 sandwiched in between to the position facing the membranous central portion 123 with the support 11 sandwiched in between. This increases the distance by which the gas flowing from the one membranous end portion 122 to the permeate side flows through the pores of the support 11 along the separation membrane 12. As a result, it is possible to further improve the separation performance of the separation membrane complex 1.

More preferably, the sealer 21 that covers and seals the surface of the support 11 on the side opposite to the surface thereof that is in contact with the other membranous end portion 122 is placed in the region of the support 11 where the other membranous end portion 122 is arranged. Preferably, the sealer 21 may extend from the position facing the other membranous end portion 122 with the support 11 sandwiched in between to the position facing the membranous central portion 123 with the support 11 sandwiched in between. This increases the distance by which the gas flowing form the other membranous end portion 122 to the permeate side flows through the pores of the support 11 along the separation membrane 12. As a result, it is possible to further improve the separation performance of the separation membrane complex 1.

As described above, the separation membrane 12 may preferably be a zeolite membrane. When the separation membrane 12 is composed of zeolite crystals having a uniform pore diameter, it is possible to favorably achieve selective permeation of a high-permeability gas. As a result, it is possible to efficiently separate a high-permeability gas from a mixed gas.

More preferably, the zeolite constituting the zeolite membrane may be composed of an 8- or less-membered ring at the maximum. In this case, it is possible to more favorably achieve selective permeation of a high-permeability gas such as CO₂ having a relatively smaller molecular size. As a result, it is possible to more efficiently separate a high-permeability gas from a mixed gas.

As described above, it is preferable that the support 11 may have a column-like shape extending in the longitudinal direction, and the separation membrane 12 may be arranged on the inner surfaces of the membrane-formed cells (i.e., the first cells 111a) that penetrate the support 11 in the longitudinal direction. In the zeolite membrane complex 1, as described above, the sweep gas can be supplied from the membranous end portions 122 on each first cell 111a. Thus, the sweep gas can be more efficiently supplied to the vicinity of the separation membrane 12 even in those of the first cells 111a on which the effect of accelerating permeation by the sweep gas is not so much exerted when the sweep gas flows along the outer surface 112 of the separation membrane complex 1 (e.g., those of the first cells 111a that are located in the vicinity of the central portion of the separation membrane complex 1 in a section perpendicular to the longitudinal direction). As a result, it is possible to further improve the separation performance of the separation membrane complex 1.

The above-described separation apparatus 2 includes the above-described separation membrane complex 1 and the housing 22 that includes the separation membrane complex 1. The housing 22 is connected to the supplier 26, the permeated gas collector (i.e., the second collector 28), and the non-permeated gas collector (i.e., the first collector 27). The supplier 26 supplies a mixed gas containing a plurality of types of gases to the separation membrane complex 1. The second collector 28 collects a permeated gas that has permeated the separation membrane 12 in the mixed gas. The first collector 27 collects a non-permeated gas that has not permeated the separation membrane 12 in the mixed gas. As described above, the separation apparatus 2 can efficiently separate the mixed gas.

The above-described separation apparatus 2 is particularly suitable for use in cases where the mixed gas contains at least one or more types of substances among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

The above-described method of producing the separation membrane complex 1 includes the step of bringing the porous support 11 into contact with the dispersion 74 in which the seed crystals 73 of a zeolite are dispersed, so as to deposit the seed crystals 73 on the support 11 (step S12), the step of immersing the support 11 with the seed crystals 73 deposited thereon in the starting material solution 76 and growing the zeolite from the seed crystals 73 by hydrothermal synthesis so as to form a zeolite membrane as the separation membrane 12 on the support 11 (step S13), and the step of, before step S12, bringing a portion of the support 11 that is within a range of one-tenth or less of the longitudinal length of the support 11 from the longitudinal edge of the support 11, into contact with a liquid that has a lower concentration of the seed crystals 73 than the dispersion 74 (i.e., the pre-processing liquid 71). This produces the separation membrane complex 1 that achieves improved separation performance as described above.

The separation membrane complex 1, the separation apparatus 2, and the method of producing the separation membrane complex 1 described above may be modified in various ways.

For example, on the outer surface 112 of the support 11, the sealer 21 does not necessarily have to extend from the position facing the membranous end portions 122 with the support 11 sandwiched in between to the position facing the membranous central portion 123 with the support 11 sandwiched in between, and the sealer 21 may be formed only at the positions facing the membranous end portions 122 with the support 11 sandwiched in between. Alternatively, the sealer 21 may not be formed on the outer surface 112 of the support 11.

In the separation membrane complex 1, if the end permeance ratio of one membranous end portion 122 of the separation membrane 12 is 5 times or more and 100 times or less, the end permeance ratio of the other membranous end portion 122 may be lower than 5 times, or may be higher than 100 times.

In the separation membrane complex 1, the zeolite constituting the zeolite membrane, which serves as the separation membrane 12, may be composed of a more than 8-membered ring at the maximum. The separation membrane 12 is not limited to a zeolite membrane, and may be an inorganic membrane such as a silica membrane or a carbon membrane or may be an organic membrane such as a polyimide membrane or a silicone membrane. The separation membrane complex 1 may further include a functional membrane or a protection membrane that is laminated on the separation membrane 12, in addition to the separation membrane 12. Such a functional membrane or a protection membrane may be a zeolite membrane, or may be an inorganic membrane or an organic membrane other than a zeolite membrane.

The structure of the separation membrane complex 1 is not limited to the example described above, and may be modified in various ways. For example, the slits 117 that penetrate the second cells 111b may be omitted. The cells 111 provided in the support 11 does not necessarily need to include the second cells 111b having both longitudinal ends plugged, and all of the cells 111 may have both ends open, and the separation membrane 12 may be formed on the inner surfaces of all of the cells 111. In other words, all of the cells 111 may be the first cells 111a. Alternatively, the number of first cells 111a may be one.

The separation membrane complex 1 does not necessarily need to be produced by the aforementioned production method (steps S11 to S14) and may be produced by any of various other production methods.

The separation membrane complex 1 may be used for the separation of a mixed gas in a mixed gas separation apparatus that differs in structure from the aforementioned separation apparatus 2. Alternatively, the separation membrane complex 1 may be used for the separation of fluid other than a mixed gas (e.g., a mixed solution obtained by mixing two or more types of liquids). As another alternative, the separation membrane complex 1 may be used in combination with the catalysts as a membrane reactor.

The configurations of the above-described preferred embodiment and variations may be appropriately combined as long as there are no mutual inconsistencies.

### INDUSTRIAL APPLICABILITY

The present invention can be utilized as a separation apparatus for separating various mixtures of substances.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 separation membrane complex
2 separation apparatus
11 support
12 separation membrane
21 sealer
22 housing
26 supplier
27 first collector
28 second collector
71 pre-processing liquid
73 seed crystal
74 dispersion
76 starting material solution
111a first cell
121 edge
122 membranous end portion
123 membranous central portion
S11 to S14, S21 to S22 step

1. A separation membrane complex comprising:
a porous support; and
a separation membrane formed on said support,
wherein average CF₄ permeance of one membranous end portion is 5 times or more and 100 times or less of average CF₄ permeance of a membranous central portion,
said one membranous end portion being one of membranous end portions of said separation membrane that are within a range of one-tenth of a longitudinal length of said separation membrane from both longitudinal edges of said separation membrane,
said membranous central portion being a portion of said separation membrane excluding said membranous end portions on both longitudinal sides.

2. The separation membrane complex according to claim 1, wherein
the average CF₄ permeance of said one membranous end portion is 5 times or more and 50 times or less of the average CF₄ permeance of said membranous central portion.

3. The separation membrane complex according to claim 1, wherein
average CF₄ permeance of the other membranous end portion is 5 times or more and 100 times or less of the average CF₄ permeance of said membranous central portion.

4. The separation membrane complex according to claim 1, further comprising:
a sealer that covers and seals a surface of said support on a side opposite to a surface of said support that is in contact with said one membranous end portion, in a region of said support where said one membranous end portion is arranged, and
said sealer extends from a position facing said one membranous end portion with said support sandwiched in between to a position facing said membranous central portion with said support sandwiched in between.

5. The separation membrane complex according to claim 1, wherein
said separation membrane is a zeolite membrane.

6. The separation membrane complex according to claim 5, wherein
a zeolite constituting said zeolite membrane is composed of an 8- or less-membered ring at a maximum.

7. The separation membrane complex according to claim 1, wherein
said support has a column-like shape extending in a longitudinal direction, and
said separation membrane is formed on an inner surface of a membrane-formed cell that penetrates said support in the longitudinal direction.

8. A mixed gas separation apparatus comprising:
the separation membrane complex according to claim 1; and
a housing that includes said separation membrane complex,
wherein said housing is connected to:
a supplier that supplies a mixed gas containing a plurality of types of gases to said separation membrane complex;
a permeated gas collector that collects a permeated gas in said mixed gas, the permeated gas having permeated said separation membrane complex; and
a non-permeated gas collector that collects a non-permeated gas in said mixed gas, the non-permeated gas having not permeated said separation membrane complex.

9. The mixed gas separation apparatus according to claim 8, wherein
said mixed gas contains one or more types of substances among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

10. A method of producing a separation membrane complex, comprising:
a) bringing a porous support into contact with a dispersion in which seed crystals of a zeolite are dispersed, to deposit said seed crystals on said support;
b) immersing said support having said seed crystals deposited thereon in a starting material solution and growing the zeolite from said seed crystals by hydrothermal synthesis to form a zeolite membrane as a separation membrane on said support; and
c) before said operation a), bringing a portion of said support that is within a range of one-tenth or less of a longitudinal length of said support from a longitudinal edge of said support, into contact with a liquid that has a lower concentration of said seed crystals than said dispersion.
